(19) United States
(12) Patent Application Publication
(10) Pub. No.: US 2008/0022756 A1
(43) Pub. Date: Jan. 31, 2008

(54) Measuring device

(76) Inventors: Ronald F. Wilson, Buckingham (GB); Peter Carpenter, Cambridge (GB)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/904,772

(22) Filed: Sep. 28, 2007

Related U.S. Application Data
(62) Division of application No. 10/543,749, filed on Oct. 26, 2005.

(30) Foreign Application Priority Data
Jan. 24, 2003 (GB) GB0301723.3

(51) Int. Cl. G01N 15/08

(52) U.S. Cl. 73/38

(57) ABSTRACT

A sleeve comprising a hollow elongate body (3) have two ends, which sleeve is suitable for elastically gripping a rolled smoking article or a filter rod for rolled smoking articles in an airtight or substantially airtight fashion; characterized in that the sleeve is formed by molding whereby each end is molded with an annular portion (4, 6) which can be folded circumferentially outwardly without imposing substantial strain on the material of the sleeve. The invention further provides a head assembly for a pressure drop and/or ventilation measuring device comprising such a sleeve, and a method for measuring the pressure drop or ventilation of a roller smoking article or a filter rod, using a pressure drop and/or ventilation measuring device having such a head assembly.

### CROSS-REFERENCES TO RELATED APPLICATIONS

The present application is a Divisional Patent Application of U.S. patent application Ser. No. 10/543,749, filed Oct. 26, 2005, entitled “SLEEVE FOR ELASTICALLY GRIPPING ROLLED SMOKING ARTICLES DURING TESTING” (as amended) which is hereby incorporated by reference in its entirety application Ser. No. 10/543,749 is a national stage filing (371) of and claims foreign priority benefits under 35 U.S.C. 119(a)-(d) of the following foreign applications for patent: PCT/GB04/00252 filed Jan. 22, 2004, entitled “IMPROVED MEASURING DEVICE”, and United Kingdom Patent Application No. GB 2003000001723, filed Jan. 24, 2003, which are hereby incorporated by reference in their entirety.

The present invention relates to improvements in and relating to pressure drop and/or ventilation measuring devices for rolled smoking articles and the like. The invention is especially concerned with the provision of an improved sleeve for use in such a measuring device for gripping a rolled smoking article or the like during the measurement of pressure drop and/or ventilation.

The quality and performance of a rolled smoking article such as a cigarette, cigar or cigarillo, may be affected by many factors; including the density of packing and the moisture content of the tobacco, and the physical dimensions of the article. Likewise, the quality and performance of filters for rolled smoking articles will depend on a variety of factors, such as the uniformity and density of the packed filter material.

Among the parameters typically measured for the purpose of assessing the quality of a cigarette or filter is the pressure drop along the length of the cigarette or filter. The pressure drop of a cigarette is directly related to the draw resistance experienced by the smoker, with a higher pressure drop requiring the smoker to work harder in order to draw smoke from the cigarette. Ventilation, another parameter used for assessing cigarette quality, is a measure of the airflow into the cigarette through pores provided in the cigarette and tipping papers. Increased ventilation results in dilution of the cigarette smoke with air. As with changes in pressure drop, this will have a direct effect on the smoker's perception and enjoyment of the product.

Devices for measuring pressure drop and/or ventilation are known in the art. Such devices typically comprise a container defining a bore having one open end, which bore is shaped to accommodate a rolled smoking article or filter rod, and means for applying a vacuum to the bore so as to draw air into the bore and through an article or filter rod accommodated within the bore. Means are provided for measuring the resultant flowrate of air through the article or filter rod and/or the pressure drop along the length of the article or filter rod, whereby a measurement of ventilation or pressure drop may be achieved.

Clearly, it is important that the rolled smoking article or filter rod should be firmly held within the bore by airtight means, whereby the flow of air along the bore juxtaposed (but not through) the article or rod will be prevented. However, it is desirable to ensure that the article or rod is not physically damaged or deformed in any way, as this may alter the pressure drop or ventilation of the product, resulting in a misleading measurement. Typically, therefore, the bore of the measuring device is fitted with one or more latex sleeves which serve to grip the article or rod in an airtight fashion during the measuring process without substantially deforming the article or rod. The latex sleeves commonly in use in the art for this purpose comprise a tube of latex material, which is usually manufactured by dipping.

It has however been found that such latex sleeves tend to suffer from fatigue and failure and, as a result, require frequent replacement. This is both inconvenient and costly in terms of equipment “down-time”.

It is an object of the present invention therefore to provide an improved sleeve of the kind suitable for elastically holding a rolled smoking article or filter rod in a substantially airtight fashion within the bore of a pressure drop/ventilation measuring device, which improved sleeve does not suffer to the same extent from the aforementioned defects.

According to one aspect of the present invention therefore, there is provided a sleeve comprising a hollow elongate body having two ends, which sleeve is suitable for elastically gripping a rolled smoking article or a filter rod for rolled smoking articles in an airtight or substantially airtight fashion; characterised in that said sleeve is formed by moulding whereby each of said ends is moulded with an annular portion which can be folded circumferentially outwardly without imposing substantial strain on the material of the sleeve.

The present inventors have observed that the fatigue and failure of the prior art latex sleeves is initiated principally at and around each end of the sleeve. When the sleeve is fitted to the bore of a measuring device, each end of the tubular sleeve is folded circumferentially outwardly over a corresponding circumferential flange provided in or around the bore, whereby the sleeve is held firmly in position within the bore. The act of turning each end of the sleeve over a flange results in substantial deformation of the tubular configuration of the sleeve, which gives rise to a high degree of localised strain, leading to the generation of an early failure point.

In contrast, the sleeve of the present invention, being moulded to enable each end of the sleeve to be folded circumferentially outwardly without imposing substantial strain on the material of the sleeve, may be fitted to the bore of a measuring device in the aforementioned manner without giving rise to early failure points at either end of the sleeve. Thus, the product life of a sleeve in accordance with the invention may be significantly longer than that of a prior art latex sleeve.

Suitably, said annular portion of each end of the body may comprise a cup or lip portion having an internal diameter larger than the internal diameter of the elongate body, and an annular shoulder portion which joins said cup or lip portion to the elongate body. In such embodiments, therefore, the step of circumferentially folding the annular portion will involve folding the shoulder portion such that the cup portion or lip portion is turned inside out or inverted. To facilitate this, the sleeve may be moulded such that the thickness of the sleeve material forming said cup or lip portion is greater than the thickness of the sleeve material forming said shoulder portion. This will also serve to improve the resilience of said cup or lip portion.

Conveniently, the thickness of the sleeve material forming said annular shoulder portion may be the same as the thickness of the sleeve material forming said elongate body. Said thickness may be in the range about 0.2-0.5 mm. Said annular shoulder portion may have a substantially frustoconical or curved frustoconical configuration, which tapers in internal diameter from the internal diameter of the cup or lip portion to the internal diameter of the elongate body. Suitably, the axial length of the shoulder portion may be no more than about 4 mm, preferably no more than about 3 mm, more preferably no more than about 2 mm. Suitably, the axial length of the shoulder portion may be at least 1 mm.

Where said annular portion of each end of the body comprises a cup portion, said cup portion may have a substantially cylindrical configuration. Optionally, said cup portion may comprise a circumferential lip remote from said shoulder portion, which circumferential lip protrudes radially outwardly from the outer surface of said cup portion. Said circumferential lip may be adapted such that when said annular portion of the sleeve is folded circumferentially outwardly for gripping a flange provided in or around a bore, said circumferential lip can engage with a corresponding annular rebate provided in said flange.

Where said annular portion of each end of the body comprises a lip portion, said lip portion may comprise a circumferential lip which protrudes radially outwardly from the sleeve and is positioned such that when said annular portion of the sleeve is folded circumferentially outwardly for gripping a flange provided in or around a bore, said circumferential lip can engage with a corresponding annular rebate provided in said flange. This will improve the grip of the sleeve on the bore.

Suitably, the internal diameter of said elongate body may be slightly smaller than the diameter of a rolled smoking article or filter rod, such as to enable the elongate body to elastically grip the rolled smoking article or filter rod in an airtight fashion. Thus, where the sleeve is to be used for gripping a cigarette or filter rod for cigarettes, the internal diameter of the sleeve may be about 5-7 mm, such as about 6 mm, depending upon the diameter of the cigarette or filter rod.

Said sleeve may be used for elastically gripping a rolled smoking article or a filter rod either for the purposes of a pressure drop test, or for the purposes of a ventilation test, or for the purposes of both a pressure drop test and a ventilation test. Where said sleeve is to be used for the purposes of a pressure drop test only, the length of said sleeve may preferably be greater than the length of said rolled smoking article or said filter rod, in order to enable said sleeve to grip the article or rod effectively along the whole of the length thereof. Thus, said sleeve may have a length in the range about 25-300 mm, preferably in the range about 50-250 nm, most preferably in the range about 150-200 mm. Suitably, said sleeve may be sufficiently long to grip the longest standardised smoking article or filter rod. Said sleeve may preferably be moulded with an annular cup portion at each end thereof, which cup portion may have an axial length in the range about 3-15 mm; preferably less than about 10 mm; more preferably in the range about 5-10 mm.

Conversely, where said sleeve is to be used for the purposes of a ventilation test, the length of said sleeve may preferably be selected such as to enable selected lengths of the rolled smoking article or filter rod to be covered for the purposes of the ventilation test, whilst permitting effective gripping of said article or rod. Thus, said sleeve may have a length in the range about 3-50 mm, more preferably in the range about 5-30 mm, even more preferably in the range about 10-20 mm. Said sleeve may preferably be moulded with an annular lip portion at each end thereof.

Advantageously, said sleeve may be formed by injection moulding. Thus, the sleeve may be formed from any elastic material which is capable of being injection moulded. In some embodiments, said sleeve may comprise a silicone material, such as a silicone rubber. In preferred embodiments, said sleeve may comprise a cured silicone rubber. As is well known to the man skilled in the art, various additives may be incorporated into silicone rubber in order to modulate its characteristics, particularly its mechanical properties, according to particular requirements. A suitable mouldable material for formation of the sleeve is available from Dow Corning STI, and is sold by the Harboro Rubber Co Ltd, St Mary's Road, Market Harborough, Leics LE16 7EE, UK under the reference KP-109. Said material may be cured and moulded into the desired shape in accordance with methods well known in the art.

According to another aspect of the present invention, there is provided a head assembly for a pressure drop and/or ventilation measuring device, which head assembly defines an elongate bore that is adapted for accommodating a rolled smoking article or a filter rod for rolled smoking articles, wherein one end of the bore is open and the other end of the bore is adapted to communicate with vacuum means whereby air may be drawn into said bore and through an article or rod accommodated within the bore and/or with a source of pressurised gas whereby pressurised gas may be propelled into said bore and through an article or rod accommodated within the bore; characterised in that said bore comprises at least one pair of spaced circumferential flanges positioned within or around said bore, which flanges respectively engage the opposing annular portions of a sleeve in accordance with the invention such that said sleeve is fitted to the interior of said bore and is positioned for elastically gripping a rolled smoking article or filter rod therein.

Said annular portions of the sleeve may accordingly be moulded so as to enable an optimum fit between said annular portions of the sleeve and said flanges. Where said flanges have configurations differing from one another, said annular portions of the sleeve may also be moulded with configurations differing one from the other.

Optionally, one or both of said circumferential flanges may comprise an annular rebate provided on the outer surface thereof, which annular rebate is adapted to engage a circumferential lip provided on said sleeve.

In some embodiments, said sleeve may be arranged to extend along the full length of said bore, such as to grip said rolled smoking article or filter rod along the entire length thereof. In this case, the head assembly will be suitable for use in a device capable of measuring pressure drop only, but not ventilation. Said circumferential flanges may accordingly be respectively provided at each of the opposing ends of the bore. Conveniently, each of said circumferential flanges may define a respective end of the bore.

In other embodiments, said or each pair of flanges may be positioned within said bore such that a rolled smoking article or filter rod accommodated within said bore is gripped along a part of the length thereof. Conveniently, each pair of flanges may be defined by an annular protrusion or bobbin provided on the walls of said bore, which annular protrusion or bobbin has a substantially T-shaped cross-section. The axial length of said annular protrusion or bobbin, and hence of the sleeve engaging said annular protrusion or bobbin, may be in the range about 5-30 mm, such as about 10-20 mm.

According to yet another aspect of the present invention, there is provided a method for measuring the pressure drop or ventilation of a rolled smoking article or a filter rod, comprising the steps of providing a pressure drop and/or ventilation measuring device having a head assembly in accordance with the invention, placing said article or rod within the bore of said head assembly such that the article or rod is gripped by said or each sleeve, connecting said other end of the bore to vacuum means or to a source of pressurised gas and operating said vacuum means or said source of pressurised gas to respectively draw air or propel gas into said bore and through said article or rod, and measuring the resultant airflow or pressure difference along said article or rod.

Following is a description, by way of example only, and with reference to the accompanying drawings, of embodiments of the present invention.

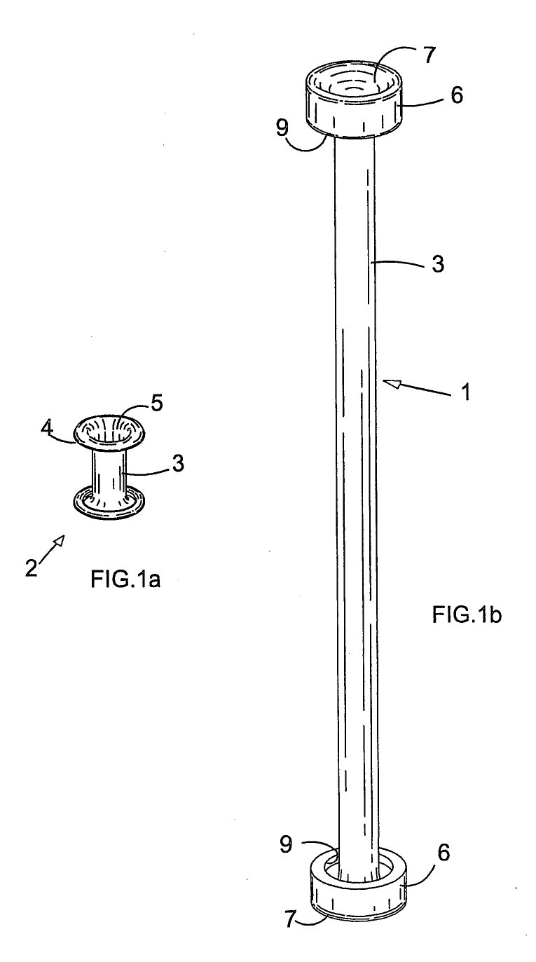

FIG. 1a shows an isometric view of a first sleeve in accordance with the invention;

FIG. 1b shows an isometric view of a second sleeve in accordance with the invention;

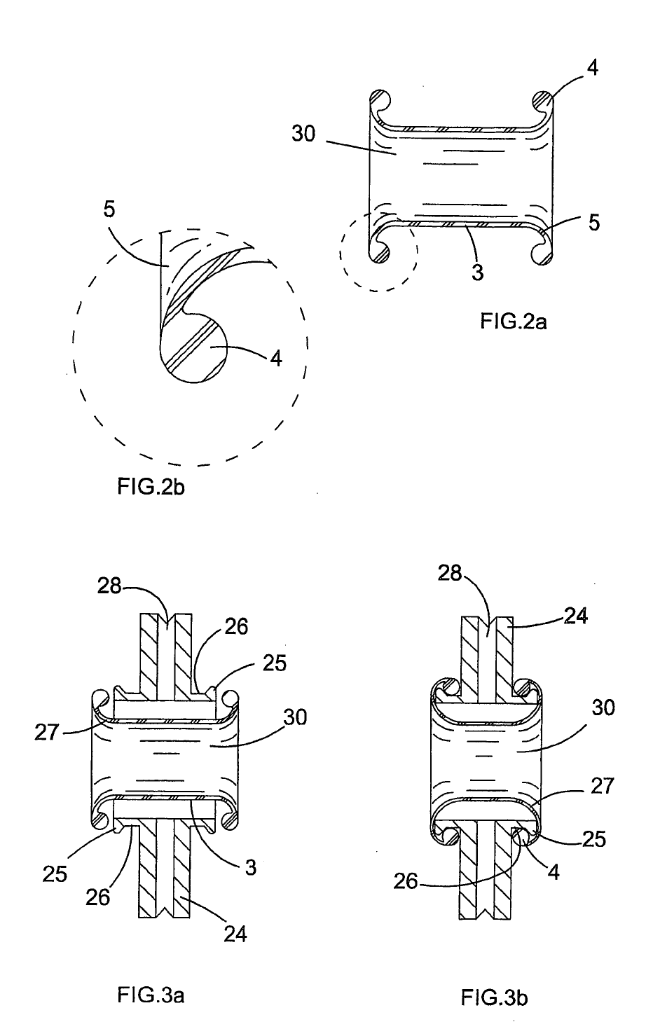

FIG. 2a shows a cross-sectional side view of the sleeve of FIG. 1a;

FIG. 2b shows an enlarged view of a part of FIG. 2a;

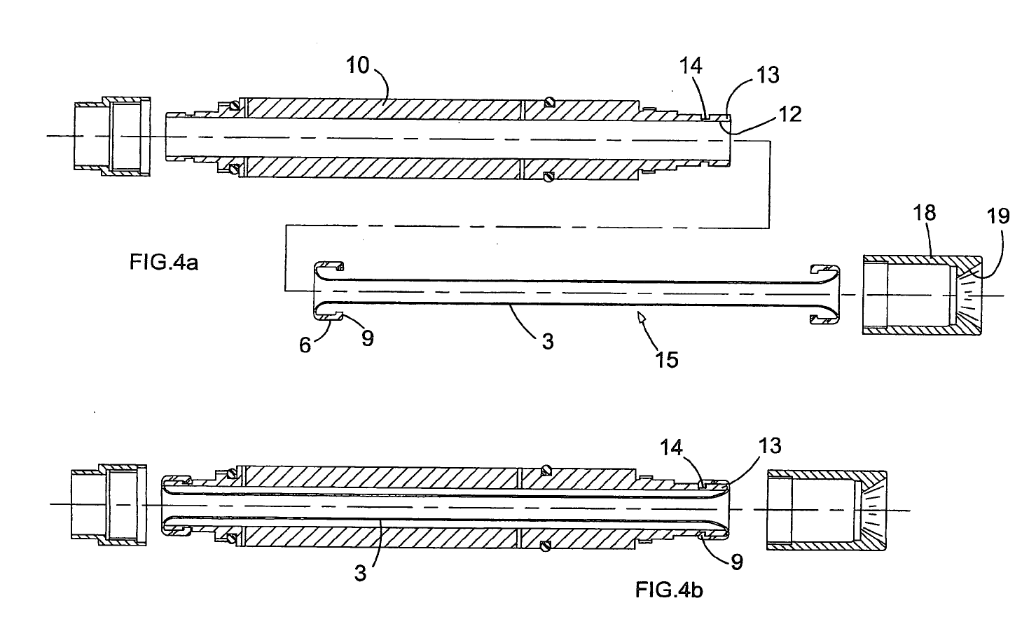

FIGS. 3a and 3b illustrate the assembly of the sleeve of FIG. 1a with a bobbin;

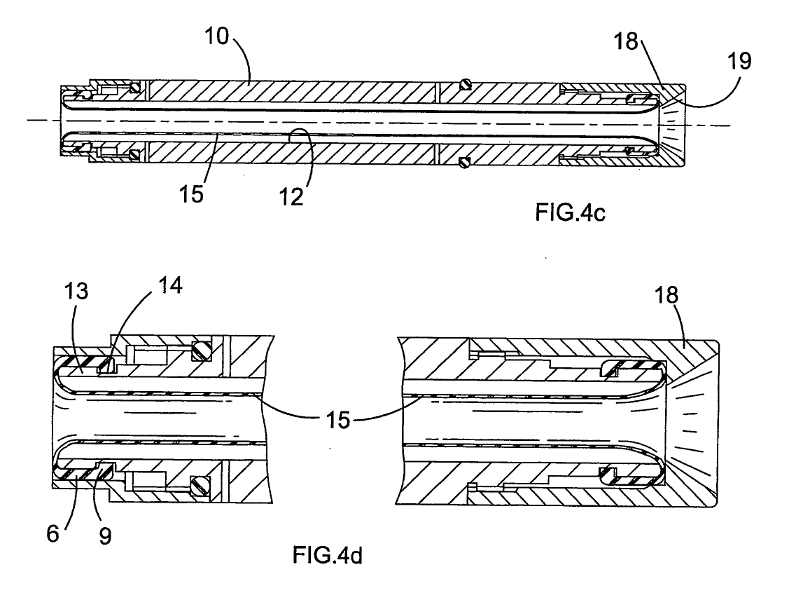

FIGS. 4a-4d illustrate the assembly of the sleeve of FIG. 1b with a bobbin;

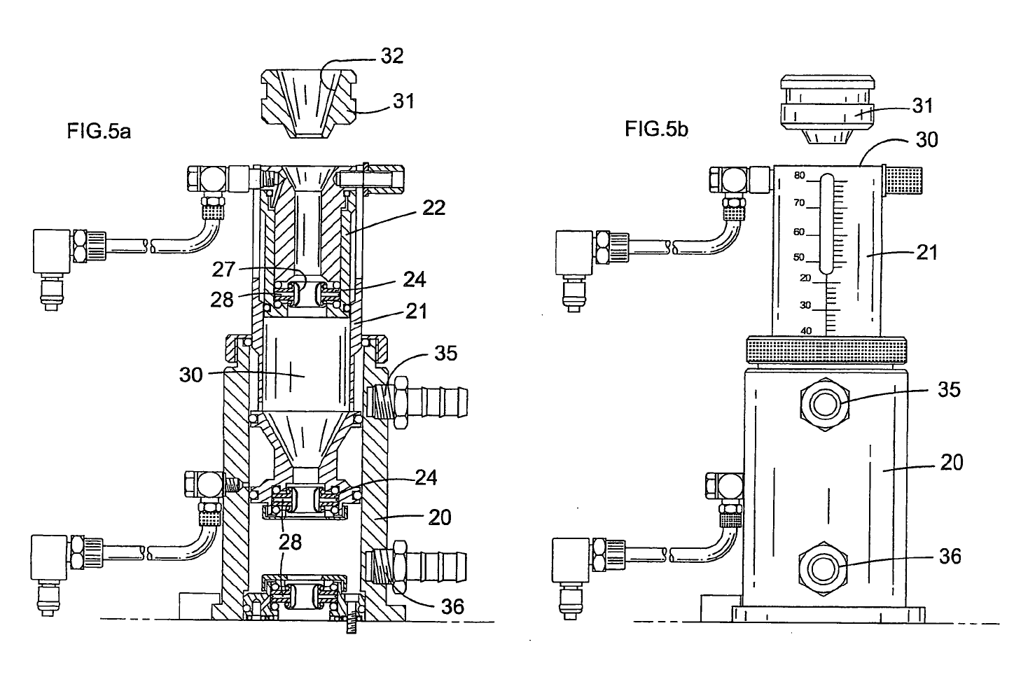

FIG. 5a shows a cross-sectional front view of a head assembly in accordance with the invention for a pressure drop and/or ventilation measuring device;

FIG. 5b shows a front view of the head assembly of FIG. 5a;

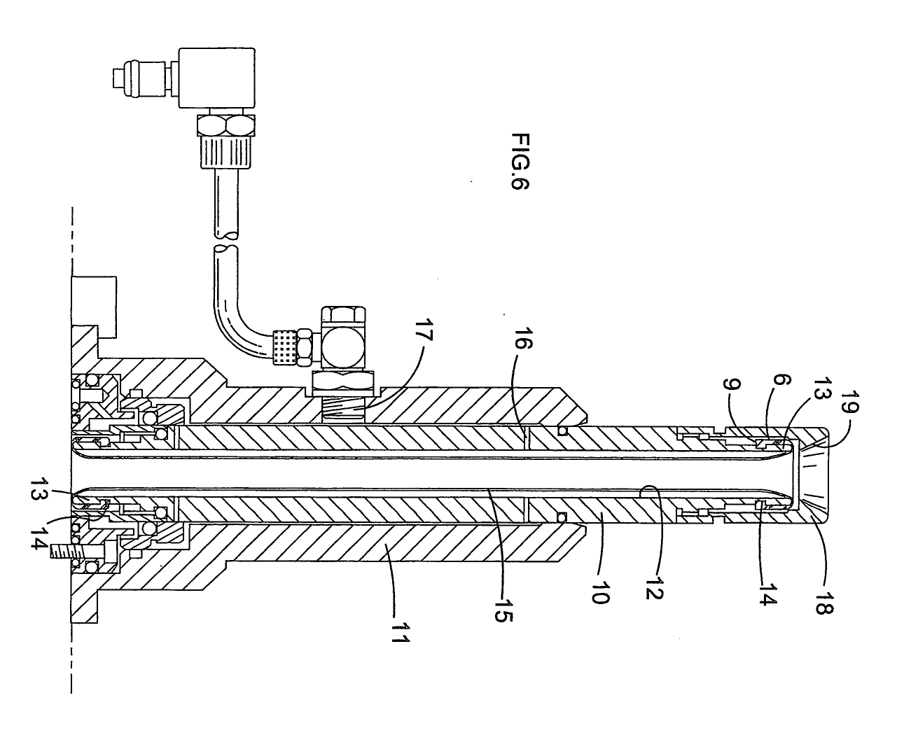

FIG. 6 shows a cross-sectional front view of a head assembly in accordance with the invention for a pressure drop measuring device.

Two embodiments of sleeves in accordance with the present invention are shown in FIGS. 1a and 1b. FIG. 1a shows a sleeve which comprises a hollow elongate body 3 approximately 10 mm in length having a cylindrical configuration with an internal (unstretched) diameter of approximately 6 mm, which is slightly smaller than the average diameter of a cigarette or filter rod therefor. The walls of the body have a thickness of approximately 0.3 mm. As seen in FIG. 2a, each end of the elongate body 3 is formed integrally with an outwardly-tapering curved frustoconical shoulder portion 5 which terminates in an annular lip portion 4 having an internal (unstretched) diameter of approximately 10.25 mm; that is, a diameter larger than the internal diameter of the elongate body 3. Said annular lip portion 4 is substantially circular in axial cross-section and has an axial cross-sectional diameter of about 1.5 mm, which is substantially greater than the thickness of the walls of the elongate body.

FIG. 1b, meanwhile, shows a sleeve which comprises a hollow elongate body 3 of cylindrical configuration having a length of approximately 140 mm and an internal (unstretched) diameter of approximately 6 mm, which is slightly smaller than the average diameter of a cigarette or filter rod therefor. The walls of the body have a thickness of approximately 0.3 mm. Each end of the elongate body 3 is formed integrally with an outwardly-tapering shoulder portion 7 and a cylindrical cup portion 6 having an internal (unstretched) diameter of approximately 12 mm, which is larger than the internal diameter of the elongate body. As seen in FIG. 1b, the provision of said shoulder portion 7 permits each cylindrical cup portion 6 of the sleeve to be readily turned inside out and folded outwardly along the length of the body 3. Because the cylindrical cup portion 6 has a larger diameter than the body 1, this does not impose a substantial strain on the material of the sleeve at the shoulder portion 7.

Each cylindrical cup portion 6 of the sleeve has a thickness of approximately 0.7 mm, which is greater than the thickness of the elongate body 3 of the sleeve. This improves the resilience and gripping power of the cylindrical portion 6. Each cylindrical cup portion 6 of the sleeve further includes an annular lip portion 9 which protrudes from said cylindrical cup portion 6 around the opening of said cylindrical cup portion. Said annular lip portion 9 is substantially circular in axial cross-section and has an axial cross-sectional diameter of about 1.5 mm.

The sleeves shown in FIGS. 1a and 1b are formed from cured silicone rubber, and are injection moulded into the shapes illustrated. The silicone rubber used for forming the sleeves is commercially available from Dow Corning STI or from The Harboro Rubber Co Ltd, St Mary's Road, Market Harborough, Leics LE16 7EE under product reference KP109. Physical characteristics of this material are given below

| Test | Result |
|---|---|
| Hardness Shore A | 51 |
| Hardness IRHD | 56 |
| Specific Gravity | 1.13 |
| Tensile strength | 7.06 MPa |
| Elongate at break | 440% |
| Compression set 22 hrs 175° C. | +16.53% |
| Tear strength | 10.50 N/mm |
| Low temp flex −55° C. | Pass |
| Heat age 70 hrs 225° C. | |
| Hardness change | +3 |
| Tensile change | +2.26% |
| Elongation change | −4.54% |
| ASTM 1 swell 70 hrs 150° C. | |
| Hardness change | −6 |
| Tensile change | +6.09% |
| Elongation change | +2.27% |
| Volume change | +1.63% |
| ASTM 3 swell 70 hrs 150° C. | |
| Hardness change | −12 |
| Tensile change | +27.81% |

Where the silicone rubber is supplied in block form, the rubber is first milled into sheet form having a thickness of approximately 6-7 mm, and cut into blanks having a weight of approximately 10 g and a diameter of approximately 25 mm.

Each blank is moulded into the desired shape in a conventional manner using a cavity injection tool. The silicone material contains a curing agent which cross-links during the moulding process, at a rate which is dependent on pressure, temperature and time. Typically, curing is permitted to occur over a period of about 5 minutes at a temperature of 175° C.

Each of the sleeves shown in FIGS. 1a and 1b is adapted to be fitted to a head assembly for a pressure drop or ventilation measuring device in accordance with the invention. A head assembly for a device suitable for measuring pressure drop only is shown in FIG. 6. As seen in this Figure, the head assembly comprises a bobbin 10 which is securely held by a housing 11. Said bobbin 10 defines an elongate cylindrical bore 12 having a length of approximately 150 mm, each end of which is defined by an annular flange 13. Each annular flange 13 includes a circular rebate 14 on the outer surface thereof, spaced from the end of said bore.

A sleeve 15 of the kind shown in FIG. 1b is fitted to the interior of said bore 12. As seen in FIG. 6, the cylindrical cup portion 6 at each end of the sleeve 15 is turned inside out over a respective annular flange 13 of the bobbin 10, such that the sleeve 15 is secured to the bobbin. The annular lip portion 9 of each cylindrical cup portion 6 engages with said circular rebate 14 on the respective annular flange 13. This improves the fixing of said sleeve 15 on the bobbin 10.

A cap 18 is provided for fitting to the bobbin 10 at one end of the bore 12 following the fitting of said sleeve 15. The cap 18 defines a bore 19 which is arranged to communicate with said bore 12, such that the bore 12 remains open at that end notwithstanding fitting of the cap 18.

The bobbin 10 includes a duct 16 opening in a side wall of said bore 12, which duct 16 communicates with a port 17 provided on said housing 11. Port 17 is connected to a vacuum pump (not shown). When a vacuum is applied to said port 17 and said duct 16 by said vacuum pump, air is evacuated from the space between the side walls of said bore 12 and the sleeve 15. This causes the sleeve 15 to be drawn outwardly against the side walls of the bore, thereby permitting a rolled smoking article or filter rod to be introduced into the sleeve through the open end of the bore 12. When the vacuum is released, the sleeve will relax away from the side walls of the bore, owing to the elastic nature of the material from which the sleeve is formed, and will grip the article or rod in an airtight fashion, but without unduly compressing the article or rod.

A stop (not shown) is positioned juxtaposed the end of the bore 12 remote from said open end. This serves to prevent a rolled smoking article or filter rod, having been introduced into said bore through said open end, from falling out of the bore through the other end thereof.

The end of the bore 12 remote from said open end constitutes a port which may be connected to a vacuum pump for evacuating air from the bore 12, or to a controlled source of pressurised air for propelling air under a known pressure into said bore 12. Once a rolled smoking article or filter rod has been introduced into said bore 12 and is gripped by said sleeve 15, the vacuum pump or pressurised air source may be operated to respectively withdraw air from the bore or propel pressurised air into the bore and through the article or rod within the bore. A measure of pressure drop along the length of the smoking article or filter rod may be obtained by measuring the pressure at the end of the bore 12 remote from said open end.

As the device of FIG. 6 is suitable for measuring pressure drop but not ventilation, this device is typically only used in connection with filter rods, which comprise a cylindrical block of filter material shaped to be cut into lengths for inclusion in a rolled smoking article. Measurements of ventilation are not usually required for filter rods.

A head assembly for a device suitable for measuring either pressure drop or ventilation is shown in FIGS. 5a and 5b. This device is typically used in connection with rolled smoking articles, such as cigarettes, for which measurements of ventilation may be required.

As seen in FIGS. 5a and 5b, the head assembly of this device comprises a hollow tubular housing 20; a first hollow tubular member 21 which is mounted concentrically on said housing 20 such as to extend partly within said housing 20, and which is slidable within said housing 20; and a second hollow tubular member 22 which is mounted concentrically on said first tubular member 21 such as to extend partly within said member 21, and which is slidable within said member 21. Said second and first hollow tubular members and said housing together define a bore 30 which extends through said head assembly. The end of said second tubular member 22 which protrudes from said first tubular member 21 is adapted to be fitted with a cap 31, which cap 31 defines a bore 32, such that said end of the member 22 and the bore 30 remain open notwithstanding the fitting of said cap 31.

Each of said housing 20, said first tubular member 21 and said second tubular member 22 is provided at the end thereof remote from said open end with an internal annular bobbin 24, which bobbin 24 has an axial length of approximately 10 mm. As seen in FIGS. 3a and 3b, each bobbin 24 has a substantially T-shaped axial cross-section, whereby each bobbin 24 defines a pair of axially-directed flanges 25. As best seen in FIGS. 3a and 3b, each flange 25 further includes an annular rebate 26 around the radially outward surface of the flange.

A sleeve 27 of the kind shown in FIG. 1a is fitted to each bobbin 24. The elongate body 3 of the sleeve is inserted into the centre of the bobbin, and the lip portion 4 at each end of the sleeve is folded over a flange 25 of the protrusion 24 and engaged with the rebate 26 on the outer surface of the flange, as illustrated in FIG. 3b. Thus, the sleeve 27 is held firmly in position on the bobbin 24.

Each bobbin 24 includes a duct 28 which is adapted to be connected to a vacuum pump. As seen in FIGS. 3a and 3b, said duct 28 opens between said flanges 25, such that when said duct 28 is connected to a vacuum pump and said pump is operated to withdraw air from the space between said flanges 25 and the associated sleeve 27, the elongate body 3 of the sleeve will be pulled outwardly against the duct 28. This will permit a rolled smoking article or filter rod to be inserted into the bobbin and sleeve assembly. Thereafter, the vacuum may be released, thereby permitting the elongate body of the sleeve to relax away from the duct 28 and to airtightly grip the rolled smoking article or filter rod.

The bobbins 24 of said housing 20 and said first and second tubular members 21, 22 are respectively positioned so as to grip onto a rolled smoking article or filter rod at three spaced points. Typically, a rolled smoking article such as a cigarette will be inserted filter-first into the head assembly, so that the sleeve 27 associated with said housing 20 will grip the cigarette around its filter, whilst the sleeve 27 associated with said second tubular member 22 will grip the cigarette at the other end thereof. Said first and second tubular members 21, 22 may be moved slidably relative to one another and to said housing 20 so as to adjust the relative positions of said sleeves.

Ports 35, 36 are provided in said housing 20 at spaced positions along the length thereof. Each port comprises a valve which may be respectively opened and closed for permitting or preventing the access of air into said bore 30 through the port. Where a measure of the ventilation of a cigarette accommodated within said bore 30 is required, therefore, one or both of said ports 35, 36 may be opened, and a vacuum may be applied to the end of the bore 30 remote from said open end. Air will accordingly be drawn through the cigarette from the open end of the bore. Depending upon the ventilation of the cigarette, air will also be drawn through each of the open ports 35, 36. The resultant airflow into said open ports will accordingly provide a measure of the ventilation of the cigarette. By moving said first tubular member 21 relative to the housing 20, so as to grip different areas of the cigarette, a measure of the effect on ventilation of “blocking” different areas of the lining paper of the cigarette may be obtained.

1. A pressure drop measuring device comprising:
an elongate bore that is adapted for accommodating a rolled smoking article or a filter rod for rolled smoking articles;
at least one pair of spaced circumferential flanges positioned within or around said bore;
a sleeve for holding the rolled smoking article or filter rod in the elongate bore, the sleeve comprising a hollow elongate body having two ends, and wherein the sleeve is formed by molding whereby each of said ends is molded with an annular portion which can be folded circumferentially outwardly without imposing substantial strain on the material of the sleeve, wherein the sleeve can be folded circumferentially outwardly at either end thereof to be engaged with respective circumferential flanges positioned within or around said bore;
a pressurized air source being operable to draw air through the rolled smoking article or filter rod held in the sleeve; and
pressure measurement means arranged to measure the pressure in the bore.

2. A pressure drop measuring device as claimed in claim 1, wherein said annular portion of each end of the body comprises a cup or lip portion having an internal diameter larger than the internal diameter of the elongate body, and an annular shoulder portion which joins said cup or lip portion to the elongate body.

3. A pressure drop measuring device as claimed in claim 2, wherein said annular shoulder portion has a substantially frustoconical or curved frustoconical configuration, which tapers in internal diameter from the internal diameter of the cup or lip portion to the internal diameter of the elongate body.

4. A pressure drop measuring device as claimed in claim 2, wherein the axial length of said shoulder portion is no more than about 4 mm.

5. A pressure drop measuring device as claimed in claim 2, wherein the axial length of said shoulder portion is at least 1 mm.

6. A pressure drop measuring device as claimed in claim 2, wherein said annular portion of each end of the body comprises a cup portion, which cup portion comprises a circumferential lip remote from said shoulder portion, which circumferential lip protrudes radially outwardly from the outer surface of said cup portion.

7. A pressure drop measuring device as claimed in claim 1, which has a length in the range about 25-300 mm, or in the range about 3-50 mm.

8. A pressure drop measuring device as claimed claim 1, which is formed by injection molding from a material that is capable of being injection molded.

9. A pressure drop measuring device as claimed in claim 1, wherein the sleeve comprises a silicone material, such as a cured silicone rubber.

10. A pressure drop measuring device as claimed in claim 1 further comprising a stop in the elongate bore arranged to prevent a rolled smoking article or filter rod from falling out of the bore.

11. A pressure drop measuring device as claimed in claim 1, wherein one or both of said circumferential flanges comprises an annular rebate provided on the outer surface thereof, which annular rebate is adapted to engage a circumferential lip provided on said sleeve.

12. A pressure drop measuring device as claimed in claim 1, wherein said sleeve is arranged to extend along the full length of said elongate bore, such as to grip said rolled smoking article or filter rod along the entire length thereof; and said circumferential flanges are respectively provided at each of the opposing ends of the bore.

13. A pressure drop measuring device as claimed in claim 1, wherein said or each pair of flanges is positioned within said bore such that a rolled smoking article or filter rod accommodated within said bore is gripped along a part of the length thereof.

14. A pressure drop measuring device as claimed in claim 1, wherein each pair of flanges is defined by an annular protrusion or bobbin provided on the walls of said bore, which annular protrusion or bobbin has a substantially T-shaped cross-section.

15. A method for measuring the pressure drop of a rolled smoking article or a filter rod, comprising the steps of providing a pressure drop measuring device in accordance with claim 1, placing said article or rod within the bore of said pressure drop measuring device such that the article or rod is gripped by said or each sleeve, and operating said source of pressurized gas to respectively draw air or propel gas into said bore and through said article or rod, and measuring the resultant pressure difference along said article or rod.

16. A ventilation measuring device comprising:
an elongate bore that is adapted for accommodating a rolled smoking article;
at least one pair of spaced circumferential flanges positioned within or around said bore;
a sleeve for holding the rolled smoking article in the elongate bore, the sleeve comprising a hollow elongate body having two ends, and wherein the sleeve is formed by molding whereby each of said ends is molded with an annular portion which can be folded circumferentially outwardly without imposing substantial strain on the material of the sleeve, wherein the sleeve can be folded circumferentially outwardly at either end thereof to be engaged with respective circumferential flanges positioned within or around said bore;
a pressurized air source being operable to draw air through the rolled smoking article held in the sleeve, wherein air is drawn through the end of the rolled smoking article and through an area of the lining paper; and
airflow measurement means arranged to measure the airflow that is related to the ventilation of an area of the lining paper of the rolled smoking article.

17. A ventilation measuring device as claimed in claim 16 comprising: at least two pairs of spaced circumferential flanges and at least two sleeves, one associated with each pair of circumferential flanges, wherein each sleeve is arranged to grip the rolled smoking article at a different position.

18. A ventilation measuring device as claimed in claim 17 wherein each pair of spaced circumferential flanges is on a respective bobbin, and the two bobbins are moveable with respect to one another so that the rolled smoking article may be gripped at different respective positions.

19. A ventilation measuring according to claim 17 further comprising a valve arranged to allow a ventilation airflow through an area of the lining paper of the rolled smoking article.

20. A ventilation measuring device according to claim 19 wherein the airflow measurement means are arranged to measure the airflow through the valve.

21. A ventilation measuring device as claimed in claim 16, wherein said annular portion of each end of the body comprises a cup or lip portion having an internal diameter larger than the internal diameter of the elongate body, and an annular shoulder portion which joins said cup or lip portion to the elongate body.

22. A ventilation measuring device as claimed in claim 21, wherein said annular shoulder portion has a substantially frustoconical or curved frustoconical configuration, which tapers in internal diameter from the internal diameter of the cup or lip portion to the internal diameter of the elongate body.

23. A ventilation measuring device as claimed in claim 21, wherein the axial length of said shoulder portion is no more than about 4 mm.

24. A ventilation measuring device as claimed in claim 21, wherein the axial length of said shoulder portion is at least 1 mm.

25. A ventilation measuring device as claimed in claim 21, wherein said annular portion of each end of the body comprises a cup portion, which cup portion comprises a circumferential lip remote from said shoulder portion, which circumferential lip protrudes radially outwardly from the outer surface of said cup portion.

26. A ventilation measuring device as claimed in claim 16, which has a length in the range about 25-300 mm, or in the range about 3-50 mm.

27. A ventilation measuring device as claimed claim 16, which is formed by injection molding from a material that is capable of being injection molded.

28. A ventilation measuring device as claimed in claim 16, wherein the sleeve comprises a silicone material, such as a cured silicone rubber.

29. A ventilation measuring device as claimed in claim 16, wherein one or both of said circumferential flanges comprises an annular rebate provided on the outer surface thereof, which annular rebate is adapted to engage a circumferential lip provided on said sleeve.

30. A ventilation measuring device as claimed in claim 16, wherein said or each pair of flanges is positioned within said bore such that a rolled smoking article or filter rod accommodated within said bore is gripped along a part of the length thereof.

31. A ventilation measuring device as claimed in claim 16, wherein each pair of flanges is defined by an annular protrusion or bobbin provided on the walls of said bore, which annular protrusion or bobbin has a substantially T-shaped cross-section.

32. A method for measuring the ventilation of a rolled smoking article, comprising the steps of providing a ventilation measuring device in accordance claim 16, placing said rolled smoking article within the bore of said ventilation measuring device such that the article is gripped by said or each sleeve, and operating said source of pressurized gas to respectively draw air through an end of said article and through an area of the lining paper of said article, and measuring the airflow that is related to the ventilation of an area of the lining paper of the rolled smoking article.
